(19) United States
(12) Patent Application Publication
(10) Pub. No.: US 2008/0055414 A1
(43) Pub. Date: Mar. 6, 2008

(54) Modified Baird sequential detail scanning system

(76) Inventor: Stephen George Mican, West Point, CA (US)

Correspondence Address: Stephen George Mican, Post Office Box 1347, West Point, CA, 95255-1347, US

(21) Appl. No.: 11/899,195

(22) Filed: Sep. 4, 2007

Related U.S. Application Data
(60) Provisional application No. 60/842,610, filed on Sep. 5, 2006.

(51) Int. Cl. H04N 3/02; H04N 9/07

(52) U.S. Cl. 348/195; 348/266; 348/E03.001

(57) ABSTRACT

For a television scanning element with a scanning area, a method of scanning a television image comprises the steps of: scanning the scanning area at a predetermined fine detail picture scanning rate; imaging a fine detail picture of the television image onto a portion of the scanning area; and imaging more than one coarse detail picture of the television image adjacent to the fine detail picture, each coarse detail picture having a size less than the fine detail picture; wherein the imaging combination produces a fine detail image with the fine detail scan rate and a coarse detail image with a coarse detail scan rate, the coarse detail scan rate being a multiple of the fine detail scan rate equal to the number of imaged coarse detail pictures.

### CROSS REFERENCE TO RELATED APPLICATIONS

This Application claims the benefit of the filing date for prior filed co-pending Provisional Application Ser. No. 60/842,610, filed 5 Sep. 2006.

### FIELD OF THE INVENTION

The invention relates to television scanning systems, and more particularly to methods for analysing and reproducing an image by means of a television scanning system with minimal apparent flicker.

### BACKGROUND OF THE INVENTION

Television systems require a data channel with a significant amount of bandwidth in order to render pictures in motion with usable detail. Although picture or frame rates of as little as nine to 12 frames per second (FPS) may impart relatively smooth motion, apparent flicker that instantaneous displays render at such frame rates is generally objectionable with any degree of display brightness. Ideally, a television system that includes a relatively bright display of any size should have an effective frame rate of at least twice, and preferably three or four, times the minimum frame rate that imparts relatively smooth motion.

Therefore, assuming that 12 FPS is adequate to impart relatively smooth motion, a television system that has a relatively bright instantaneous display should have an effective frame rate of at least 24, and preferably 36 or 48 FPS. As a point of comparison, standard motion picture film shot at 24 frames per second has an effective frame rate of 48 frames per second by flashing each frame twice.

Of course, there is no way to flash a television frame multiple times on an instantaneous display short of storing the entire frame in some sort of electronic memory and retrieving it multiple times for this purpose. Therefore, television systems have generally used other means for increasing effective frame rate two or more times.

The most popular way to accomplish this is with an interlaced scanning (IS) television system. An IS television system scans each picture in a sequence of different line fields wherein each line field corresponds to a different sequence of lines. For instance, with an odd/even line IS television system, the first field may correspond to odd lines of the scanned picture and the second field may correspond to even lines of the scanned picture.

In this way, such an IS television system that transmits 25 frames per second achieves an effective frame rate of 50 frames per second by actually transmitting 50 odd/even line fields per second. This simple form of optical data compression has been popular for over 70 years and most television broadcasting services still use it.

An IS television system works very well for displaying stationary pictures. However, television is primarily for displaying pictures in motion and IS, being a simple form of data compression, introduces serious artefacts whilst displaying pictures in motion. This is because an IS system alternately skips lines in each field and the system distorts or loses altogether any detail approaching the size of the scanning lines with a component of motion that is normal to the scanning lines. Therefore, it is better to utilise a different form of optical data compression with progressive scanning that does not suffer from artefacts that are as severe as generated by IS television systems.

Mr John L. Baird devised such an alternative scanning system as described in British Patent Number 391,924, filed on 2 Feb. 1932. Described therein is a progressive scanning system that simultaneously transmits pictures with coarse detail at a high frame rate and pictures with fine detail at a low frame rate over a single data channel. Since the scanning is progressive, there can be no interlace-induced artefacts. Since the system reproduces each picture at a high frame rate, albeit with only coarse detail, there is no apparent flicker on an instantaneous display. Finally, the system reproduces each picture with fine detail at a frame rate sufficient to impart relatively smooth motion. The system is capable of accomplishing this with alternatively little loss in picture area or minimal increase in bandwidth compared to an IS television system.

Simply stated, Mr Baird discloses a television system that transmits progressively scanned pictures in coarse detail whilst transmitting progressively scanned sequential portions of each picture in fine detail. For instance, in the case of a vertically scanned picture, the system may transmit a rightmost third of the picture in fine detail and the entire picture in coarse detail during a first frame, then the middle third of the picture in fine detail and the entire picture in coarse detail during a second frame and finally the leftmost third of the picture in fine detail and the entire picture in coarse detail during a third frame. Thus, there are three complete coarse detail picture frames for each complete fine detail frame. If each fine detail frame has a frame rate of 12.5 FPS, sufficient to impart relatively smooth motion, then the coarse detail picture frame rate is 37.5 FPS, sufficient to minimise or eliminate apparent flicker on a display of average size and brightness.

Since the system progressively scans and a complete fine detail frame over a sequence of complete coarse detail frames, it is convenient to refer to it as the Baird sequential detail scanning (SDS) system. In his patent, Mr Baird illustrates a simple embodiment of this SDS system in FIGS. 1 through 4 that comprises a vertically scanned 24-line system. In this embodiment, the system scans the right third of the picture with eight lines of fine detail and the remainder of the picture in four lines of coarse detail in a first frame, then the middle third of the picture with eight lines of fine detail and the remainder of the picture in four lines of coarse detail in a second frame and finally the left third of the picture with eight lines of fine detail and the remainder of the picture with four lines of coarse detail. Thus, this embodiment has a coarse detail picture frame rate that is three times the fine detail picture frame rate. If the fine detail frame picture frame rate is 12.5 FPS to impart relatively smooth motion, then the coarse detail picture frame rate is 37.5 FPS to minimise or eliminate apparent flicker.

This form of optical data compression is awesome. The Baird SDS system may conceivably sequence detail in a fine detail frame over any number of coarse detail frames. For instance, if the system spreads out each fine detail frame over four coarse detail frames and the fine detail frame has a frame rate of 12.5 FPS then the coarse detail frames have a frame rate of 50 FPS, a very impressive figure.

Although Mr Baird provides a simple embodiment of the Baird SDS system that very effectively illustrates the principles of this improved form of optical data compression, it is evident that such a simple embodiment is sub-optimal for thoroughly exploiting the capabilities of the SDS system. First, the embodiment requires a special optical scanning element. It comprises a set of three spirals that have square apertures for the fine detail lines and rectangular apertures for the coarse detail lines with 36 apertures total required for rendering a 24-line picture. Second, the resolution of the coarse detail pictures is not symmetrical. That is, because the coarse detail apertures are rectangular and have the same scanning rate as the fine detail apertures, the detail in the direction of scanning is the same as the fine detail apertures. Thus, the coarse pictures reduce detail by a factor of four horizontally but not at all vertically. The SDS system may achieve maximum optical data compression if the coarse detail pictures have reduced resolution in both dimensions.

### SUMMARY OF THE INVENTION

For a television scanning element with a scanning area, the invention generally comprises a method of scanning a television image comprising the steps of: scanning the scanning area at a predetermined fine detail picture scanning rate; imaging a fine detail picture of the television image onto a portion of the scanning area; and imaging more than one coarse detail picture of the television image adjacent to the fine detail picture, each coarse detail picture having a size less than the fine detail picture; wherein the imaging combination produces a fine detail image with the fine detail scan rate and a coarse detail image with a coarse detail scan rate, the coarse detail scan rate being a multiple of the fine detail scan rate equal to the number of imaged coarse detail pictures.

### DESCRIPTION OF THE DRAWINGS

FIG. 1 is an arrangement of fine and coarse detail pictures that may line up within the scanning area of a standard scanning element for television scanning according to a possible embodiment of the invention.

FIG. 2 is an optical system for generating and combining coarse detail pictures within the scanning area of a standard scanning element for television scanning according to a possible embodiment of the invention.

### DETAILED DESCRIPTION OF THE INVENTION

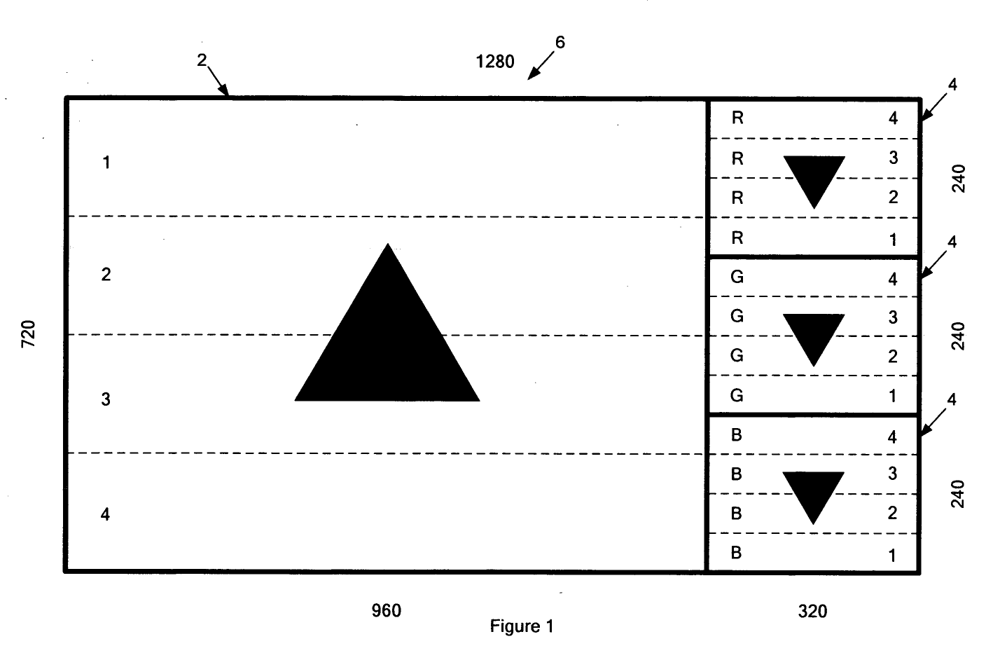

Referring to FIG. 1, a scanning process according to a possible embodiment of the invention images a fine detail picture 2 adjacent to several coarse detail pictures 4 that may line up within a scanning area 6 of a standard optically or electrically addressable scanning element (not shown). The scanning element may comprise a scanning disc or drum with apertures, lenses or mirrors, a cathode-ray pickup tube or display, or any other sort of television sensor or display, such as a CCD sensor array or LCD display. By way of example only, FIG. 1 shows a laterally scanning area 6 with a 1280 by 720 pixel, 16:9 aspect ratio. The invention is applicable to a scanning area 6 with any number of pixels, any aspect ratio, and any direction of scan. Also, any convenient number of coarse pictures 4 may combine with the fine detail picture 2. Assuming that the coarse pictures 4 are to have one-third the lateral and vertical resolution of the fine picture 2, the fine picture 2 will have a lateral resolution of 960 lines and vertical resolution of 720 lines whilst each coarse detail picture will have a lateral resolution of 320 lines and a vertical resolution of 240 lines. Thus, with lateral scanning, three coarse detail pictures 4 should line up along the left or right side of the fine detail picture 2. Preferably, the coarse detail pictures 4 are image-reversed relative to the fine detail picture 4 for reasons described hereinafter. Arbitrarily, FIG. 1 shows the coarse detail pictures 4 lined up along the right side of the fine detail picture 2 within the scanning area 6 so that with left-to right scanning, scanning of the coarse pictures 4 occurs toward the end of each scanning line. Picture synchronisation may be easier with this arrangement.

According to the invention, to achieve minimum bandwidth, the scanning process should scan the coarse detail pictures 4 with equal horizontal and vertical resolution and the bandwidth or data rate whilst scanning the coarse detail pictures should approach that whilst scanning the fine detail picture 2. In other words, since the lateral resolution of the coarse detail pictures 4 is one third that of the fine detail picture 2, the vertical resolution of each coarse picture 4 should be one third of the fine detail picture 2 and the scanning rate for each coarse detail picture 4 should be three times as fast as that of the fine detail picture 2.

Since the fine detail picture 2 should have three times the resolution of each coarse detail picture 4, the fine detail picture 4 should be three times as wide as each coarse detail picture. With 1280 pixels available for both the fine detail picture 2 and the coarse detail pictures 4 in the lateral dimension, the number of pixels for the fine detail picture 2 in the lateral dimension should then be an integer evenly divided by three that is closest to 1280×(¾)=960. The resolution of the fine detail picture 2 is then 960 by 720 pixels and the resolution of each coarse definition picture is 320 by 240 pixels. This results in an aspect ratio for both coarse and fine detail pictures of 4:3. The total scanning area 6 of the coarse detail pictures 4 lined up along the right side of the fine detail picture 2 is then 1280 by 720 pixels.

Note that scanning with this arrangement works exactly like shown in Mr Baird's patent, except that resolution of the coarse detail pictures 4 is uniformly one third of the fine detail picture and that the scanning process comprises scanning four complete coarse detail pictures 4 for every fine detail picture 2. This may not be evident at first glance, but note that the coarse detail pictures 4 are image-reversed with respect to the fine detail picture 2. In this way, whilst the scanning process scans the first one fourth of the fine detail picture, which contains both coarse and fine detail for the first one fourth of the fine detail picture 2, it also scans the last three fourths of the first coarse detail picture 4. Thus, the scanning process creates a full first picture with coarse detail during this period. Whilst the scanning process scans the second fourth of the fine detail picture 2, which contains both coarse and fine detail for the second one fourth of the fine detail picture 2, it also scans the first fourth of the first coarse detail picture 4 and the third and last fourth of the second coarse detail picture 4, thereby creating a full second picture with coarse detail during this period. Whilst the scanning process scans the third fourth of the fine detail picture 2, which contains both coarse and fine detail for the third one fourth of the fine detail picture 2, it also scans the first and second fourths of the second coarse detail picture 4 as well as the first fourth of the third coarse detail picture 4, thus creating a full third picture with coarse detail during this period. Finally, whilst the scanning process scans the last fourth of the fine detail picture 2, which contains both coarse and fine detail for the last fourth of the fine detail picture 2, it also scans the first three fourths of the third coarse detail picture 4. Thus, if the scanning process scans the fine detail picture 2 at a rate of 12.5 FPS to impart relatively smooth motion, then it scans the coarse detail pictures at four times this rate, or 50 FPS, to minimise or eliminate apparent flicker.

The required bandwidth is in this instance is 5.76 mHz. As a point of comparison, without any form of optical compression, a television system that offers an image with 960 by 720 pixels at 50 FPS would require a bandwidth of 17.28 mHz. This is an effective compression of three to one: better than the two to one compression available with traditional odd/even line interlacing.

The scanning process according to the invention may pass each of the three coarse pictures 4 through a different primary colour filter so that each of the three coarse pictures 4 represent a different primary colour portion of a full colour picture. The scanning process combines the three different primary colour image-reversed coarse detail pictures 4 with the fine detail picture 2 to form a complete colour picture with coarse detail represented in colour and fine detail represented in monochrome, much like other colour television systems in current use.

There is no increase in bandwidth by adding colour in this fashion. However, the resulting full colour picture is of a field sequential nature with a colour picture frame rate that is the same as the fine detail picture frame rate, or 12.5 FPS in the hereinbefore described example. For pictures that contain large areas of saturated colour, flicker may be apparent at such a low effective frame rate. For pictures that have low or no colour saturation, apparent flicker should approach the coarse picture detail frame rate of 50 FPS.

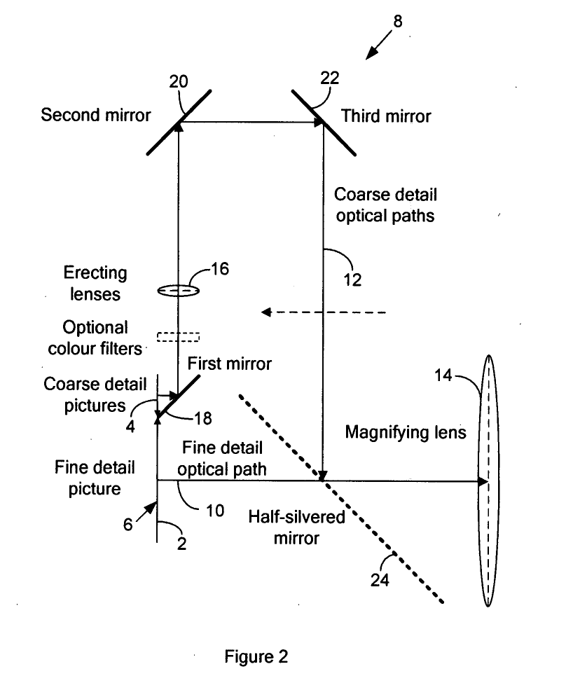

A plethora of different fixed optical systems are suitable for generating and combining the fine detail picture 2 with the image-reversed coarse detail pictures 4, but FIG. 2 shows a simple optical system 8 by way of example for use in reproducing an SDS television signal with a scanning process according to the invention using a standard optically or electrically addressable scanning element that reproduces a composite picture with the format shown in FIG. 1. The optical system 8 comprises a fine detail optical path 10 for fine detail picture and a coarse detail optical path 12 for each coarse detail picture.

The fine detail optical path 10 may simply comprise a converging magnification lens 14 wherein the optical system 2 positions the magnification lens 14 at a distance from the fine detail picture 2 in the scanning area 6 that is less than the focal length of the magnifying lens 14 to produce an erect magnified virtual image of the fine detail picture 2. For instance, if the magnifying lens 14 has a focal length of 16 cm, then positioning the magnification lens 14 at a distance of 8 cm from the fine detail picture 2 produces an erect virtual image of the fine detail picture magnified by a factor of two. Assuming the scanning area has a width of 4 cm so that the fine detail picture is 3 cm wide and each coarse detail picture is 1 cm wide, the virtual image of the fine detail picture is 6 cm wide. The total length of the fine detail optical path is 8 cm.

Each coarse detail optical path 12 may comprise a converging erecting lens 16 that produces an erect magnified real image of its corresponding image-reversed coarse detail picture. Furthermore, the three coarse detail optical paths 12 intersect the fine detail optical path 10 to produce a composite fine and coarse detail image through the magnifying lens 14. For instance, if each erecting lens 16 has a focal length of 2.25 cm, then positioning each erecting lens a distance of 3 cm from its respective coarse detail picture produces an erect real image of the respective image-reversed coarse detail picture magnified by a factor of three at a distance of 12 cm from the erecting lens. With the erect real image of each coarse detail picture positioned the same distance from the magnification lens as the fine detail picture, that is, 8 cm, the magnification lens shall produces an erect virtual image of each coarse detail picture that is magnified by a factor of two. Furthermore, the optical system 8 cants each of the erecting lenses 16 to superimpose its respective virtual image on the virtual image of the fine detail picture 2, thereby forming a composite image of the fine and coarse detail pictures. The total length of each coarse detail optical path is 23 cm.

The optical system 8 folds each coarse detail optical path 12 to converge it through the magnification lens 14 with the fine detail optical path 10. A first mirror 18, a second mirror 20 and third mirror 22, in combination with a half silvered mirror 24, provide folded coarse detail optical paths 12 with the proper optical length and direction for each of these paths as well to superimpose the virtual image of each coarse detail picture 4 on the virtual image of the fine detail picture 2. In this example, the rotational axis of the first mirror is 0.5 cm from the coarse detail pictures 4 and the centreline of each erecting lens is 2.5 cm from the axis of the first mirror 18. The axis of the second mirror 20 is 4.75 cm from the centreline of each erecting lens 16 and the axis of the third mirror 22 is 3.5 cm from the axis of the second mirror 20. Finally, the axis of the half-silvered mirror 24 is 7.75 cm from the axis of the third mirror 22 and the axis of the half-silvered mirror 24 intersects the centreline of the fine detail optical path 10 a distance of 4 cm from the centreline of the magnifying lens 14.

The same arrangement is suitable for generating the generated fine detail picture 2 and the coarse detail pictures 4 within the scanning area of a standard optically or electrically addressable scanning element in a television camera. The optical system 8 then projects the fine detail picture 2 and the coarse detail pictures 4 upon the scanning area 6 of a standard optically or electrically addressable scanning element as shown in FIG. 2.

Optionally, the optical system 8 may mount a different primary colour filter 26 in each coarse detail optical path 12 to render a field sequential full colour television image. The optical system 8 combines the three primary colour coarse detail pictures 4 with the fine detail picture 2 to capture or reproduce a full colour composite picture.

Of course, the scanning process according to the invention may comprise as little as two coarse detail pictures 4 in combination with a fine detail picture 2 or it may comprise more than three coarse detail pictures 4 in combination with a fine detail picture 2. It may comprise multiple rows or columns of such coarse detail pictures 4 adjacent the fine detail picture 2. In the case of vertical scanning, it may be convenient to place the coarse detail pictures above or below the fine detail picture 2. The described embodiment of the invention is only an illustrative implementation of the invention wherein changes and substitutions of the various parts and arrangement thereof are within the scope of the invention as set forth in the attached claims.

The claimed invention is:

1. For a television scanning element with a scanning area, a method of scanning a television image comprising the steps of:
scanning the scanning area at a predetermined fine detail picture scanning rate;
imaging a fine detail picture of the television image onto a portion of the scanning area; and
imaging more than one coarse detail picture of the television image adjacent to the fine detail picture, each coarse detail picture having a size less than the fine detail picture;
wherein the imaging combination produces a fine detail image with the fine detail scan rate and a coarse detail image with a coarse detail scan rate, the coarse detail scan rate being a multiple of the fine detail scan rate equal to the number of imaged coarse detail pictures.

2. The method of claim 1, wherein the television scanning element comprises a television camera scanning element and the method further comprises the step of projecting the fine detail picture and the coarse detail pictures upon the scanning area of the television camera scanning element.

3. The method of claim 1, wherein the television scanning element comprises a television display scanning element and the method further comprises the step of projecting the fine detail picture and the coarse detail pictures together to form a composite fine and coarse detail television picture.

4. The method of claim 1, further comprising the step of scanning the fine detail image and the coarse detail images, wherein the coarse detail images line up along at least one side of the fine detail image.

5. The method of claim 4, wherein the step of scanning comprises lateral scanning and the coarse detail images line up along the right side of the fine detail image.

6. The method of claim 4, wherein the step of scanning comprises lateral scanning and the coarse detail images line up along the left side of the fine detail image.

7. The method of claim 4, wherein the step of scanning comprises lateral scanning and the coarse detail images line up in multiple columns along at least one vertical side of the fine detail image.

8. The method of claim 4, wherein the step of scanning comprises vertical scanning and the coarse detail images line up along the top of the fine detail image.

9. The method of claim 4, wherein the step of scanning comprises vertical scanning and the coarse detail images line up along the bottom of the fine detail image.

10. The method of claim 4, wherein the step of scanning comprises vertical scanning and the coarse detail images line up in multiple rows along at least one lateral side of the fine detail image.

11. The method of claim 1, wherein each coarse detail picture represents a different colour.

12. The method of claim 11, wherein the step of imaging the coarse detail pictures comprises imaging three of the coarse detail pictures and each coarse detail picture represents a different one of three primary colours.

13. For a television camera scanning element with a scanning area, a method of scanning a television image comprising the steps of:
projecting a fine detail picture of the television image onto a portion of the scanning area;
projecting more than one coarse detail picture of the television image adjacent to the fine detail picture, each coarse detail picture having a size less than the fine detail picture; and
scanning the fine detail picture and the coarse detail pictures together on the scanning area at a preselected fine detail picture rate;
wherein the imaging combination produces a fine detail image with a fine detail scan rate and a coarse detail image with a coarse detail scan rate, the coarse detail scan rate being a multiple of the fine detail scan rate equal to the number of projected coarse detail pictures.

14. The method of claim 13, wherein each coarse detail picture represents a different colour.

15. The method of claim 14, wherein the step of projecting the coarse detail pictures comprises projecting three of the coarse detail pictures and each coarse detail picture represents a different one of three primary colours.

16. The method of claim 14, further comprising the step of optically filtering each coarse detail picture to represent a different colour.

17. For a television display scanning element with a scanning area, a method of scanning a television image comprising the steps of:
scanning the scanning area at a predetermined fine detail picture scanning rate;
imaging a fine detail picture of the television image onto a portion of the scanning area;
imaging more than one coarse detail picture of the television image adjacent to the fine detail picture, each coarse detail picture having a size less than the fine detail picture;
projecting the fine detail picture along a fine detail optical path;
projecting each coarse detail picture along a corresponding coarse detail path; and
combining the fine detail picture optical path and the coarse detail picture paths to produce a composite fine and coarse detail picture;
wherein the composite fine and coarse detail picture produces a fine detail image with the fine detail scan rate and a coarse detail image with a coarse detail scan rate, the coarse detail scan rate being a multiple of the fine detail scan rate equal to the number of scanned coarse detail pictures.

18. The method of claim 17, wherein each coarse detail picture represents a different colour.

19. The method of claim 18, wherein the step of projecting the coarse detail pictures comprises projecting three of the coarse detail pictures and each coarse detail picture represents a different one of three primary colours.

20. The method of claim 18, further comprising the step of optically filtering each coarse detail picture to represent a different colour.
